(19) United States
(12) Patent Application Publication
(10) Pub. No.: US 2009/0104950 A1
(43) Pub. Date: Apr. 23, 2009

(54) SLIDE TYPE PORTABLE ELECTRONIC DEVICE

(75) Inventor: Shih-Jung HUANG, Taipei City (TW)

Correspondence Address: Muncy, Geissler, Olds & Lowe, PLLC, P.O. BOX 1364, FAIRFAX, VA, 22038-1364, US

(73) Assignee: INVENTEC CORPORATION

(21) Appl. No.: 12/049,802

(22) Filed: Mar. 17, 2008

(30) Foreign Application Priority Data
Oct. 17, 2007 (TW) 96138919

(51) Int. Cl. H04M 1/00

(52) U.S. Cl. 455/575.4

(57) ABSTRACT

A slide type portable electronic device is described. The slide type portable electronic device includes a first case, a second case and a multimedia coupler. The multimedia coupler including a sound box and a speaker disposed inside the sound box couples the first case to the second case. The sound box and the speaker can rotate with the first case and the first case can slide on the multimedia coupler.

### RELATED APPLICATIONS

This application claims priority to Taiwan Application Serial Number 96138919, filed Oct. 17, 2007, which is herein incorporated by reference.

### FIELD OF THE INVENTION

The present invention generally relates to a slide type portable electronic device. More particularly, the present invention relates to a slide type portable electronic device with a multimedia coupler.

### BACKGROUND OF THE INVENTION

Due to great progress in wireless telecommunication and electronic technology, the mobile phone is a portably electrical device usable almost anytime and anywhere. The mobile phone has become an important information product in modern life.

Because of current widespread mobile phone use, mobile phone manufacturers devote all their resources to improve functions of the mobile phones for greater user satisfaction. For example, some mobile phones include a personal digital assistant (PDA) function, including, for example, functions of an address book, appointment scheduler, ToDo list, and journal. Therefore, all PDA functions can be combined into the mobile phone, also referred to as a smart phone.

However, the space of the mobile phone or PDA is too tiny to accommodate all additional functions and structures therein. In particular, the dimensions of the mobile phone, generally smaller than a palm, are too small to accommodate a complete keyboard, e.g. a Qwerty keyboard, therein. Most of them only include a numerical keyboard for dialing the telephone number. Users can input English characters by pressing a numerical key multiple times to select a desired English character. The selection process on the numerical keyboard wastes operation time for character input and is so complex as to limit input speed.

Some mobile phone or PDA manufacturers therefore design a complete keyboard on another module of the mobile phone or PDA for convenient data input by sliding out or lifting up the display module on the keyboard module.

Mostly, the bottom area of a clamshell or sliding mobile phone or PDA is too small to sustain the mobile phone or PDA on a table so that it is difficult for the user to conveniently and stably operate the mobile phone or PDA on the table. However, at the moment that the multimedia is enormously voguish, the mobile phone or PDA having such a small size is difficult to further provide a suitable speaker and sound box thereon so as to reduce the music quality playing on the mobile phone or PDA.

### SUMMARY OF THE INVENTION

One object of the present invention is to provide a multimedia coupler having a sound box and a speaker disposed in the sound box to change the position and angle of the speaker according to the angle of the multimedia coupler so as to improve the music playing quality.

Another object of the present invention is to provide a slide type portable electronic device having a multimedia coupler to allow a speaker inside the multimedia coupler to rotate together with a display of the slide type portable electronic device. To achieve these and other advantages and in accordance with the objects of the present invention, as the embodiment broadly describes herein, the present invention provides a slide type portable electronic device, for example, a mobile phone, a personal digital assistant or a smart phone. The slide type portable electronic device includes a first case, a second case and a multimedia coupler. The multimedia coupler is connected to the first case and the second case. The first case is slidable on the multimedia coupler. Furthermore, the multimedia coupler further includes a speaker rotatable together with the first case.

The first case is preferably a display and the second case is preferably a base including a keyboard, such as a Qwerty keyboard.

The multimedia coupler can further include a third case to cover the speaker and form an independent sound box for the speaker disposed therein. The third case is preferably complementary to the second case and is preferably U-shaped. The multimedia coupler preferably includes an angle controller and a sliding device, for example, a sliding rail and a slide, to allow the first case to slide and rotate on the multimedia coupler, and the speaker and the sound box to rotate together with the first case.

Another aspect of the present invention is to provide a multimedia coupler for connecting a display and a base of a portable electronic device. The multimedia coupler includes a case, a sliding device coupled between the display and the base, a hinge coupled between the base and the case, a sound box disposed in the case, and a speaker disposed in the sound box.

The case is preferably complementary to the base and is preferably U-shaped. In one embodiment, two independent sound boxes are respectively disposed on two ends of the U-shaped case and speakers are respectively disposed inside the sound boxes. Furthermore, the multimedia coupler preferably includes an angle controller to control the angle between the display and the base.

Hence, the slide type portable electronic device according to the present invention can provide a better music playing quality for users with the sound boxes disposed in the multimedia coupler. In addition, the sound boxes and the speakers can be adjusted to the angle and position thereof according to the angle of the display so as to provide a better angle and position for users to listen to the music. The second case of the slide type portable electronic device, having the protrusion portion, effectively increases the bottom supporting area thereof so that the user can conveniently and stably operate the slide type portable electronic device on the table.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIGS. 1A-1D illustrate various operation states of a preferred embodiment of a slide type portable electronic device according to the present invention; and

FIG. 2 illustrates a schematic view to show of the configuration of speakers, sound boxes and hinges of the preferred embodiment of the slide type portable electronic device according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

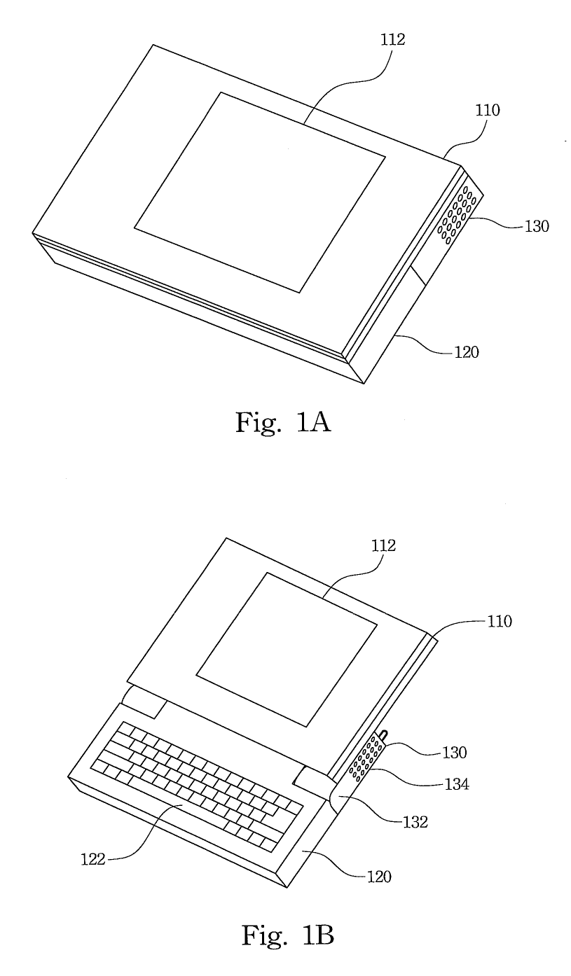

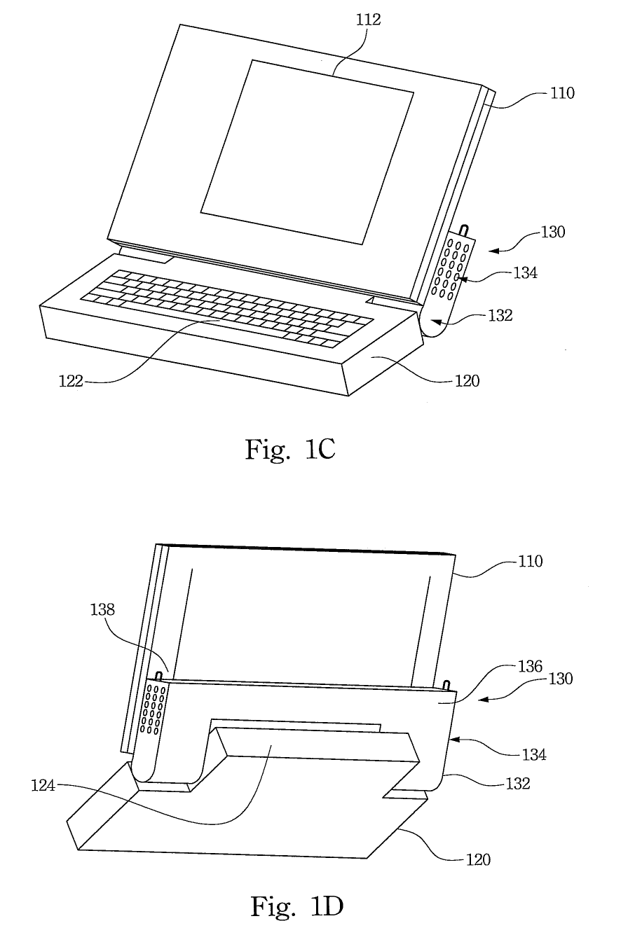

FIGS. 1A-1D illustrate various operation states of a preferred embodiment of a slide type portable electronic device according to the present invention. The slide type portable electronic device includes a first case 110, a second case 120 and a multimedia coupler 130. The first case 110 further includes a display 112 such as a flat panel display, for example, a liquid crystal display and so on. The second case 120 is preferably equipped with a keyboard 122, for example, a Qwerty keyboard.

Simultaneously referring to FIG. 1B and FIG. 1C, the first case 110 can slide on the multimedia coupler 130 and the multimedia coupler 130 can rotate together with the first case 110 when the first case 110 is slid to one end of the multimedia coupler 130. Therefore, the angle between the first case 110 and the second case 120 can be changed according to the user's request to clearly view the content displaying on the display 112.

The multimedia coupler 130 preferably includes a speaker 134 and a hinge 132. Referring to FIG. 1D, the speaker 134 disposed inside the multimedia coupler 130 is rotated together with the first case 110 so as to change a position and an angle of the speaker 134 according to the angle change of the first case 110 to effectively improve the music quality played by the speaker 134 when the multimedia coupler 130 is rotated upwardly together with the first case 110. In addition, the multimedia coupler 130 further includes a third case 136 to cover the components thereof. The multimedia coupler 130 is, for example, U-shaped. The second case 120 preferably includes a protrusion portion 124 to mate with the third case 136. When the first case 110 is rotated upwardly, the protrusion portion 124 can protrude from the multimedia coupler 130 so as to improve the stability of the slide type portable electronic device disposed on a table.

In addition, the multimedia coupler 130 can further utilize a sliding device 138, such as a sling rail and a slide, to slidably couple the first case 110 to the multimedia coupler 130. Therefore, the first case 110 can easily slide on the multimedia coupler 130. In addition, when the first case 110 moves to a predetermined position, the sliding device 138 can further utilize a locking device to fix the first case 110 on the sliding device 138.

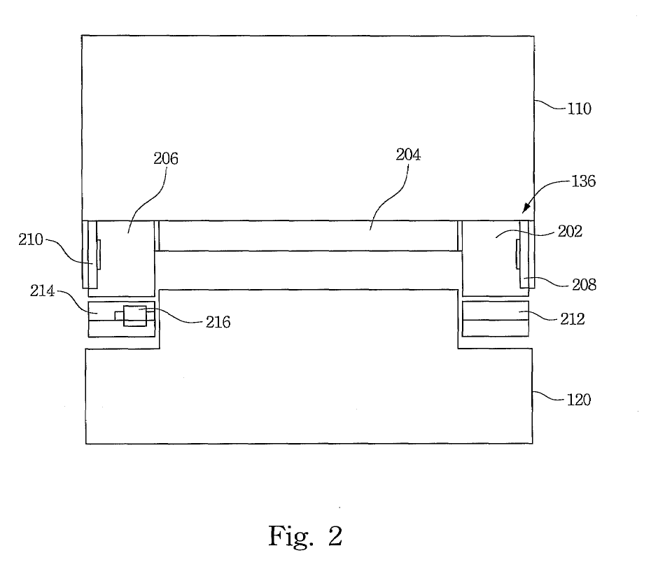

Refer to FIG. 2. FIG. 2 is a schematic view to show of the configuration of speakers, sound boxes and hinges of the preferred embodiment of the slide type portable electronic device according to the present invention. Both sides of the multimedia coupler 130 can be equipped with respective sound boxes 202/206. In addition, speaker main bodies 208/210 are further disposed inside the sound boxes 202/206. The multimedia coupler 130 of the present invention adopts the sound box 202/206 to enclose the speaker main bodies 208/210 with respective independent and closed boxes so as to effectively improve the sound effects of the speakers. Referring to FIG. 2 again, a first hinge 212 and a second hinge 214 are disposed under the sound box 202/206, or inside the sound box 202/206, so that the sound box 202/206 can rotate together with the first case 110. The sound box 202 and the sound box 206 can be further connected together with each other by a connecting portion 204 to enhance the strength of the multimedia coupler 130. Furthermore, at least one of the first hinge 212 and the second hinge 214 can be equipped with an angle controller 216 to control the angle of the first case 110, and also the angle of the display 112, for the user to conveniently watch the display 112.

Accordingly, the slide type portable electronic device according to the present invention can utilize the sound boxes disposed in the multimedia coupler to provide a better music playing quality for users. In addition, the sound boxes and the speakers can be adjusted to the angle and position thereof according to the angle of the display so as to provide a better angle and position to listen to the music. Furthermore, the base portion, i.e. the second case, includes the protrusion portion to effectively increase the bottom supporting area thereof so that the user can conveniently and stably operate the slide type portable electronic device on the table. Moreover, the protrusion portion is complementary to the multimedia coupler to provide a smooth appearance for the slide type portable electronic device.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A slide type portable electronic device, comprising:
a first case;
a second case; and
a multimedia coupler connected to the first case and the second case, wherein the multimedia coupler further comprises a speaker rotatable together with the first case, and the first case is slidable on the multimedia coupler.

2. The slide type portable electronic device of claim 1, wherein the multimedia coupler further comprises a third case having at least one independent sound box and the speaker disposed in the sound box.

3. The slide type portable electronic device of claim 2, wherein the second case further comprises a protrusion portion complementary to the third case.

4. The slide type portable electronic device of claim 3, wherein the third case is U-shaped.

5. The slide type portable electronic device of claim 1, wherein the first case further comprises a display.

6. The slide type portable electronic device of claim 1, wherein the second case further comprises a keyboard.

7. The slide type portable electronic device of claim 1, wherein the multimedia coupler further comprises an angle controller.

8. The slide type portable electronic device of claim 1, wherein the multimedia coupler further comprises a sliding device coupled to the first case.

9. The slide type portable electronic device of claim 1, wherein the slide type portable electronic device is a mobile phone.

10. The slide type portable electronic device of claim 1, wherein the slide type portable electronic device is a personal digital assistant.

11. A multimedia coupler for connecting a display and a base of a portable electronic device, comprising:
a case;
a sliding device coupled between the display and the base;
a hinge coupled between the base and the case;
a sound box disposed in the case; and
a speaker disposed in the sound box.

12. The multimedia coupler of claim 11, wherein the case is complementary to the base.

13. The multimedia coupler of claim 12, wherein the case is U-shaped.

14. The multimedia coupler of claim 11, wherein the hinge further comprises an angle controller to control an angle between the display and the base.
